(19) United States
(12) Patent Application Publication
(10) Pub. No.: US 2010/0094897 A1
(43) Pub. Date: Apr. 15, 2010

(54) UNIFIED FORMAT FOR DIGITAL CONTENT METADATA

(75) Inventors: Harry Sumrall, San Francisco, CA (US); Richard Williams, Pleasant Hill, CA (US); Scott San Filippo, San Francisco, CA (US)

Correspondence Address: SCHWEGMAN, LUNDBERG & WOESSNER, P.A., P.O. BOX 2938, MINNEAPOLIS, MN, 55402, US

(73) Assignee: GRACENOTE, INC., Emeryville, CA (US)

(21) Appl. No.: 12/521,335

(22) PCT Filed: Jan. 3, 2008
(86) PCT No.: PCT/US2008/050130

§ 371 Date: Dec. 31, 2009

Related U.S. Application Data
(60) Provisional application No. 60/883,642, filed on Jan. 5, 2007.

(51) Int. Cl. G06F 17/30

(52) U.S. Cl. 707/769; 707/E17.014; 707/E17.009

(57) ABSTRACT

A method and system to provide a unified format for digital content metadata are described. The system may include a module to obtain source data associated with media content; a module to identify, based on the source data, the media content; an extractor to obtain metadata associated the identified content; and a converter to format the obtained metadata according to the popular music format. The popular music format is a tree field format, where the fields are to store the title of the album, the title of the track, and the name of the artist.

### CLAIM OF PRIORITY

This PCT application claims the benefit of the filing date of U.S. Provisional Patent Application Ser. No. 60/883,642 filed Jan. 5, 2007 entitled, “Method and System To Provide A Unified Format of Digital Content Metadata,” which priority is hereby claimed under 35 U.S.C. §119(e), the entire content of which is incorporated herein by reference.

### TECHNICAL FIELD

This application relates to a method and system to provide a unified format for digital content metadata.

### BACKGROUND

Over the course of the past millennium, western classical music documentation has been subject to the myriad whims, uses and needs of innumerable scholars, archivists, publishers, performers, and others. The result is a hodgepodge of categorization and codification that defies common practice and application. In the emerging digital world, which crosses aesthetic, cultural, and commercial boundaries, there is no coherent and consistent classical data standard that can be universally applied in the digital realm.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example embodiment may be implemented;

FIG. 2 is a block diagram of a Three Line Solution (TLS) system in accordance with one example embodiment;

FIG. 3 is a flow chart of a method to provide a unified format for digital content metadata, in accordance with an example embodiment;

FIG. 4 is a diagrammatic representation of an architecture utilizing a three line solution (TLS), in accordance with an example embodiment;

FIGS. 5-8 are block diagrams illustrating conversion of metadata associated with works of various genres into a display format associated with works of popular music, in accordance with one example embodiment;

FIG. 9 is a diagrammatic representation of an architecture for uploading TLS-formatted data to a content database for access by a media player;

FIGS. 10-11 are block diagrams illustrating conversion maps in accordance with one example embodiment;

FIG. 12 is a block diagram illustrating various sources of content that may be processed by a TLS system and provided to a media player, in accordance with one example embodiment; and

FIG. 13 is a diagrammatic representation of an example machine in the form of a computer system within which a set of instructions, for causing the machine to perform any one or more of the methodologies discussed herein, may be executed.

### DETAILED DESCRIPTION

A method and system to provide a unified format for digital content metadata are described. In one example embodiment, in the context of the digital marketplace, a unified format for digital content metadata (hereinafter referred to as merely unified format) may be utilized for acquiring, storing, accessing, and displaying various components of metadata associated with digital content in the three-line popular music paradigm. Various components of metadata associated with digital content typically include the four basic components of metadata associated with classical music—Album Title, Album Artist, Track Title and Composer. The three-line popular music paradigm (that may be referred to as the pop format) commonly used in digital music products and applications may be viewed as the format of digital content metadata that includes the Performing Artist field, the Album Title field and Track Title field.

A vexing problem in providing classical music metadata to existing products and applications in the digital realm has been the equivalent of making a square set of data components fit into an existing triangular set of data fields. To provide an informed listening experience for classical music end users, a media player must list four basic data components: Composer, Recording Artist, Album Title and Track Title. Existing media players provide only three fields based on the popular music paradigm of Performing Artist, Album Title and Track Title (e.g., a title of a song). The problem is complicated by the need to devise a system in which existing data is not corrupted and one that will be elastic enough in its design to accommodate future innovations in the form of tools, forms, programs, applications and end products. There is currently no established format for consistently listing classical music data for the purpose of digital storage, playback, and display.

An example unified format where the four basic components of metadata associated with classical music (or other digital content that may have metadata that is not perfectly aligned with the three fields of the pop format) are displayed in the three line pop format may be termed a Three Line Solution (TLS). TLS may be utilized to provide to users (e.g., online music retailers, product developers, product marketers, as well as the end users) with the ability to access classical music metadata in a consistent and predictable manner. In one example embodiment, the unified format may utilize delimited data strings to provide backward and forward compatibility. Utilizing the unified format may allow integration of content represented in the unified format into existing databases that store content in the pop format. Utilizing the unified format may also facilitate an ability to expand into new data configurations and products.

Embodiments of the present invention, when deployed in a digital audio environment, may be utilized in conjunction with components of a system described in co-pending U.S. provisional application Ser. No. 60/709,650, entitled “METHOD AND APPARATUS TO CONTROL OPERATION OF A PLAYBACK DEVICE,” the content of which is incorporated herein in its entirety.

In one example embodiment, TLS overloads the existing three data fields of the pop format in such a way that all four basic components of classical music metadata are accommodated for purposes of acquisition, storage and display. This may be accomplished by combining the title of a specific work with the name of its composer, allowing the performer(s) to be displayed in the Album Artist field and the original work and its individual movements, sections, etc. to be entered in the Track Title field. By dedicating the Album Artist field to the performing artist(s), as opposed to the composer, TLS, in one example embodiment, also allows for multiple-artist and/or multiple-composer scenarios (e.g., for boxed compact disc (CD) and digital video disc (DVD) sets, compilations, collections, etc.) to default to a track-level artist. In the case of opera recordings, for example, this technique may allow for the individual singers of each scene to be listed in the order they appear on the track.

By adding the composer's name to the work title in the Track Title field, the status of the track may be expanded from a subset of an “album” to a distinct data string that can be manipulated for archival, marketing, and retail purposes. Within the data strings, in one example embodiment, TLS establishes specific sequences of data—composer name, work title, key signature, opus number, catalogue number movement number and title, etc.—separated by specific punctuation delimiters, in which each constituent component becomes a parsable subset of the entire data string. In one example embodiment, TLS protocols and guidelines also establish specific utilization of abbreviation, punctuation, capitalization, mandatory and optional data components, language-specific spellings and accents, translation, transliteration and other localized issues related to specific works, artists, and products.

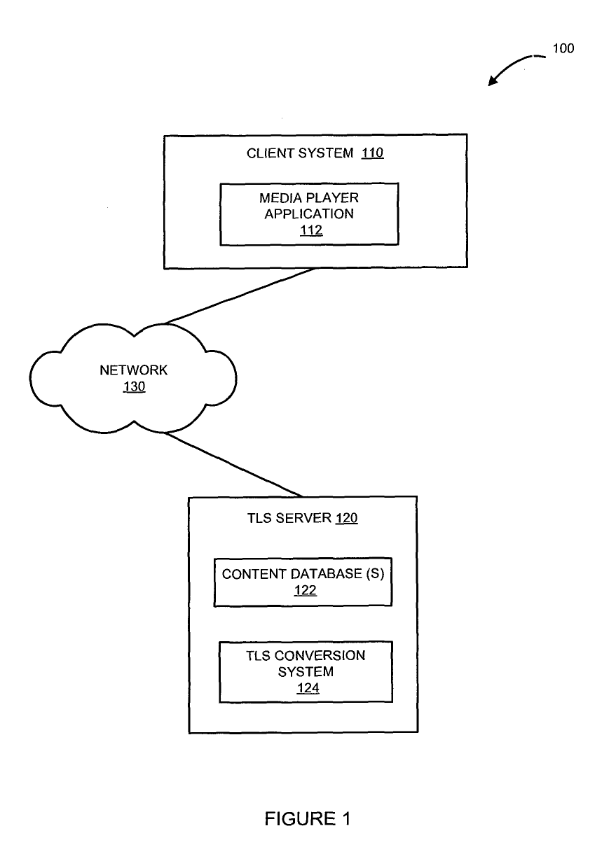

The method and system to provide a unified format for digital content metadata may be implemented, in one example embodiment, in the context of a network environment 100 illustrated in FIG. 1.

As shown in FIG. 1, the network environment 100 may include a client system (or merely a client) 110 and a TLS server 120. The client system 110 may include a media player application 112 and may have access to services provided by the TLS server 120 via a communications network 130. The TLS server 120 may host a content database 122 and a TLS application 124. The communications network 130 may be a public network (e.g., the Internet, a wireless network, etc.) or a private network (e.g., LAN, WAN, Intranet, etc.).

In one example embodiment, a user associated with the client 110 may load into a playback device a CD containing classical music in order to access the contents of the CD and request that the metadata associated with the classical content be presented in a unified format. The TLS application 124 may identify the content available on the CD, access the content, generate metadata associated with the content, process (or reformat) the metadata to organize it into the unified format, and provide the formatted metadata for display to the user. The metadata associated with the content may be obtained utilizing the content database 122. It will be noted that the content database 122 may be located locally or remotely with respect to the TLS server 120.

In another example, the client 110 may provide (e.g., via a microphone device) audio content to a content identification service that may be hosted by the TLS server 120 and request the metadata associated with the provided content. The content identification service may identify the provided digital content, and then obtain or generate the metadata associated with the identified content and provide it to the TLS application 124 for formatting.

As mentioned above, in one example embodiment, the metadata (e.g., the Album Title, the Album Artist, the Work(s) and the Composer) is formatted in a way to fit containers used for a popular music paradigm: the Performing Artist field (or Artist field), the Album Title field (or Album field), and the Track Title field (or Track field). The metadata formatted by the TLS application 124 may be stored in a normalized fashion and then returned to the end user (e.g., via the client 110). The example TLS application 124 uses series of delimiters that allows for the re-normalization of the metadata into distinct entities (e.g., the Album Title, the Album Artist, the Work(s) and the Composer) at the client system 110.

The client 110, in one example embodiment, may include a component or functional module (not shown) that may be responsible for unpacking of the formatted metadata received from the TLS application 124. The unpacking may be performed for display purposes or other applications that may need the formatted metadata.

The identifying of the content may be performed utilizing a variety of techniques, such as file-based identification (e.g., matching the name of the file with the names stored in a database, matching the file metadata with entries stored in the database, etc.), look-up the CD in a CD database (e.g., utilizing an index associated with the CD or some other identification information associated with the CD), or determining identification information associated with the content itself (e.g., using a fingerprint or a watermark associated with the audio signal).

Identification, for the purposes of this description, is a process by which digital content, e.g., digital audio content, is recognized as being the same as the original or reference recording. A fingerprint for digital content may be generated for identification purposes, in one embodiment, by utilizing intrinsic properties that may be ascertained from the audio signal. This approach utilizes the fact that the identifying features are a part of the audio signal, and therefore distinct pieces of audio content (e.g., distinct works of music) are characterized by different features.

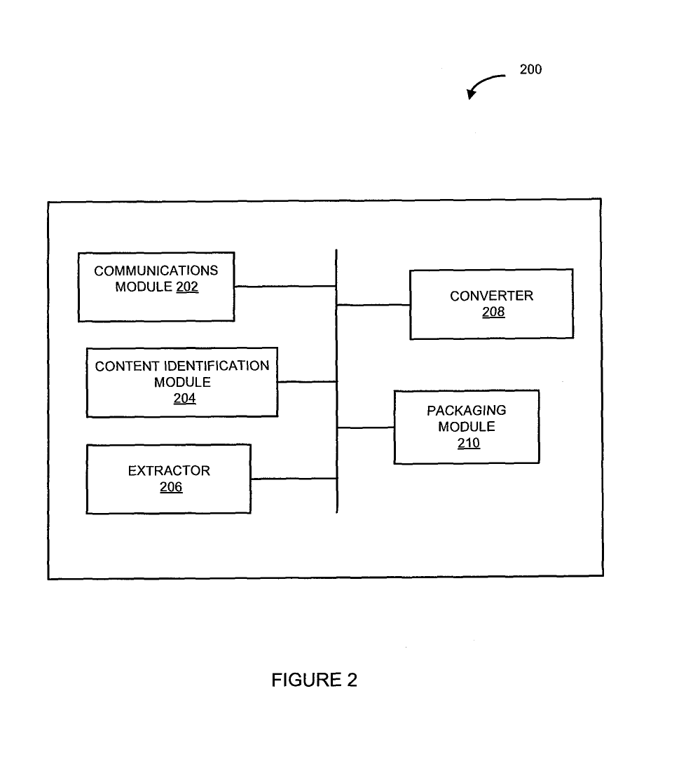

In one example embodiment a fingerprint associated with the digital content is received by the TLS application 124 and is compared with reference fingerprints that may be stored in a content database 122. It will be noted that, in one example embodiment, the content database 122 may include a plurality of databases, such as a fingerprints database to store reference fingerprints, a CD database to store data that identifies CDs, and look-up database to store various metadata associated with the content files. Example functional components of the TLS application 124 may be described with reference to FIG. 2.

FIG. 2 is a block diagram of a TLS system 200. The TLS system 200, in one example embodiment, includes a communications module 202, a content identification module 204, an extractor 206, a converter 208, and a packaging module 210. The communications module 202 may be configured to obtain or receive information associated with a subject audio content, a request to identify audio content, a request to generate metadata according to a predetermined format, or some other message or request. The extractor 204 may be configured to generate or obtain metadata associated with the audio content. Specifically, the extractor 204 may be configured to obtain information such as the Album Title, the Album Artist, the Work(s) and the Composer for a particular item of audio content.

The content identification module 204 may be configured to identify the subject content. The process of identification may be performed utilizing a variety of techniques, as mentioned earlier, e.g., by obtaining a fingerprint from the subject audio signal and matching the fingerprint with the data stored in a database associated with the TLS system 200, by performing a text match based on the name of the subject file and matching it with metadata stored in an associated database, as well as by other techniques. It will be noted that, in some embodiments, the content identification module 204 may be hosted by a computer system located remotely from the other modules of the TLS system 200. In further embodiments, the content identification module 204 may be implemented as a stand-alone application.

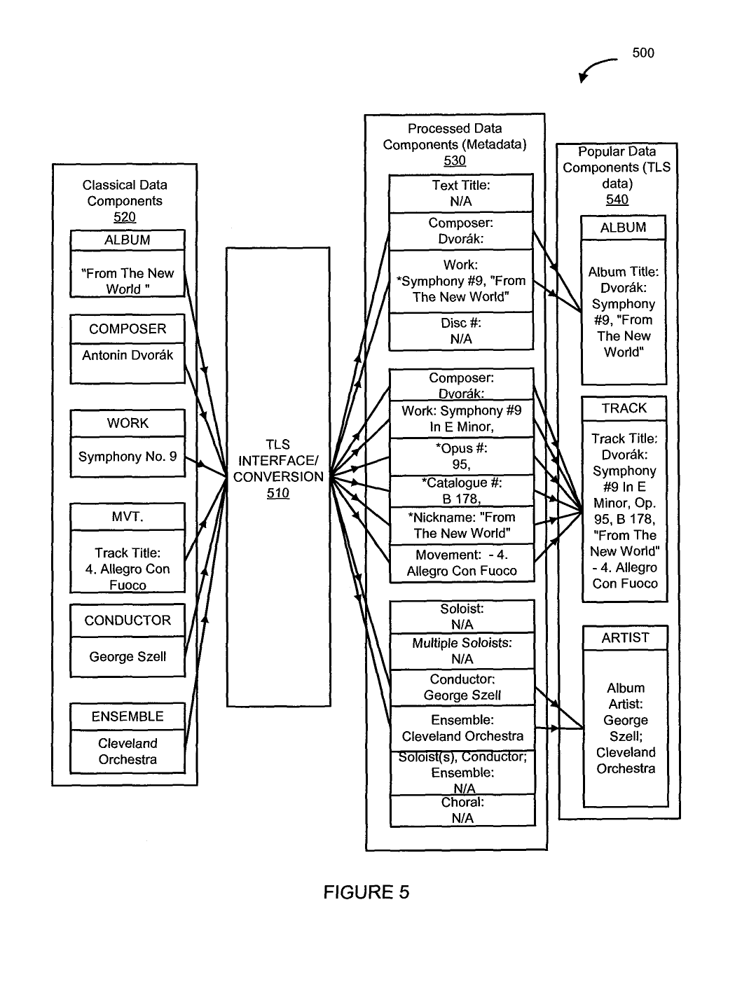

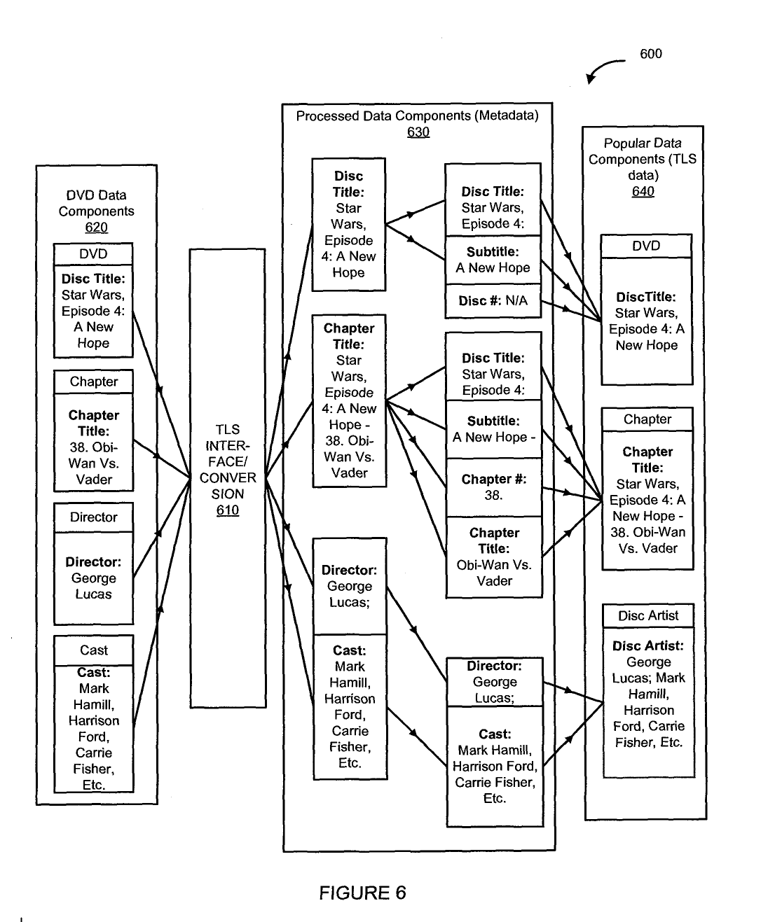

The extractor 206 may be configured to obtain metadata associated with the identified subject content, e.g., from various databases associated with the TLS system 200, e.g., the content database 122 of FIG. 1. The converter 208 may be configured to determine which pieces of information from the metadata associated with the audio content should be added in each of the three data fields associated with the pop format. For example, the metadata available to the converter 208 may include the title of the original work, which is also the name of the album, the names of the individual movements of the original work, the name of the performer, and the name of the composer. The converter 208 may combine the title of a specific work with the name of its composer and include this data into the Album Title field of the pop format. The converter 208 may include the name of the performer into the Album Artist field of the pop format, and the title of original work and the names of its individual movements, sections, etc. into the Track Title field of the pop format. An example of such conversion is illustrated in FIG. 5. Some other examples of formatting data identifying digital content are illustrated in FIGS. 6-8.

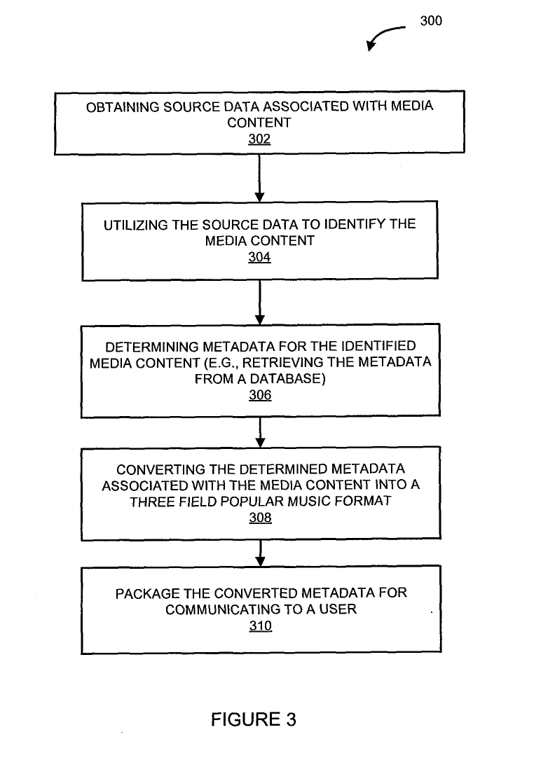

FIG. 3 is a flow chart of a method 300 to provide a unified format for digital content metadata, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the TLS server 200 of FIG. 2 and, specifically, may be provided by the TLS application 124. In one example embodiment, the method 300 may be performed by the various modules discussed above with reference to FIG. 2. Each of these modules may comprise processing logic.

As shown in FIG. 3, the method 300 commences at operation 302, where the communications module 202 of FIG. 2 obtains source data associated with media content. The media content may be audio content, e.g., a work of classical music, an operatic work, a piece of jazz music, etc. The media content may also be content from a digital video disc (DVD), e.g., a movie. At operation 304, the content identification module 204 of FIG. 2 utilizes the source data to identify the media content. For example, the media content may be Track 4 of the album “New World Symphony” featuring George Szell and the Cleveland Orchestra. At operation 306, the extractor 206 of FIG. 2, identifies (or obtains) metadata associated with the media content. In the example above, the metadata includes composer name, work name, opus#, catalogue #, nickname, movement, conductor, and ensemble. At operation 308, the converter 208 of FIG. 2, performs formatting of the obtained metadata into the format utilized for popular music that includes three fields: Album field, Artist field, and Track field. At operation 310, the metadata thus converted into a tree-field popular music format is packaged for communicating to a user (e.g., to a playback device or application).

An example TLS system described herein may be implemented to provide a standard to provide consistency across classical eras and genres, compatibility with the existing popular (pop) music data representation paradigm, the ability to convey the pertinent data about a recording for an informed listening experience, as well as scalability for future technological innovations and applications. This standard may be utilized beneficially to convert metadata associated with a variety of presentation or media content genres, e.g., jazz, opera, movies, etc. For the purposes of this description, the unified format and the associated standard, while not limited to applications to classical music metadata, will be referred to as Classical Standard.

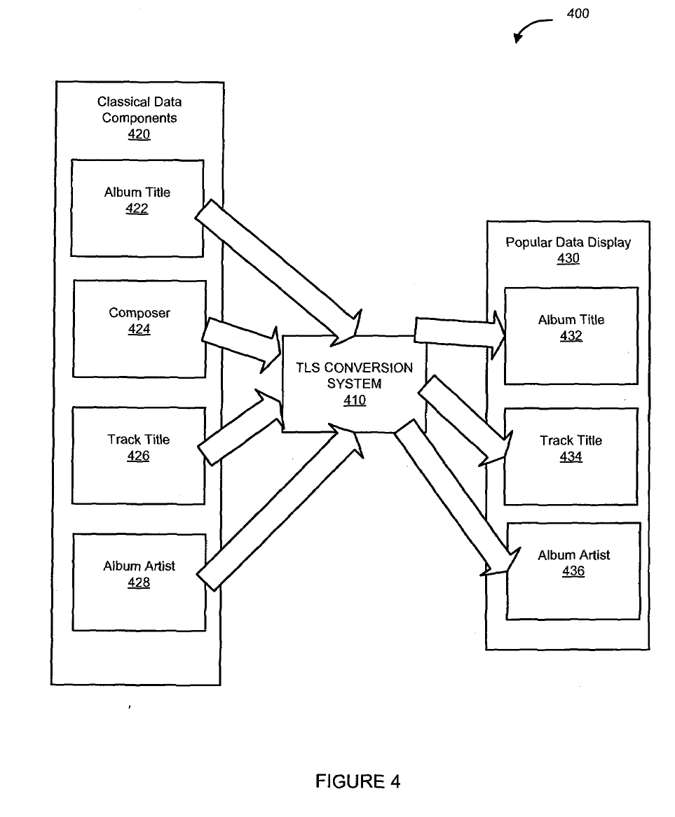

In one example embodiment, the centerpiece of the Classical Standard is the Three-Line Solution (TLS). Example architecture 400 utilizing TLS is illustrated in FIG. 4. Example TLS conversion system 410 may be used to convert classical data components 420 into popular data display 430. Example classical data components 420 include an album title item 422, a composer item 424, a track title item 426, and an album artist item 428. As shown in FIG. 4, metadata associated with a source content item (e.g., an item of classical piece of music) is used to populate the track, artist, and album fields (fields 432, 434, and 436 respectively) associated with popular music format. As shown below, data items that are mandatory in this example embodiment appear in square brackets. Data that is optional in this example embodiment appears in braces (“{ }”).

Example Solution: [ ]=Mandatory data { }=Optional data.

Track: [Composer Short Name]: [Work Title] In {Key}, {Opus #}, {Catalogue #}, {“Nickname”}—[Mvt #]. [Mvt tempo or text title].

Artist: {Soloist(s)}, {Conductor}; {Ensemble}, {Choral Ensemble}.

Album: As printed on the product, with exceptions.

Examples below of metadata associated with classical music formatted to conform to the popular music Track/Artist/Album display convention illustrate this approach.
Track: Beethoven: Symphony #6 In F, Op. 68, “Pastoral”—1. Allegro Ma Non Troppo
Artist: Herbert Von Karajan; Berlin Philharmonic Orchestra
Album: Beethoven: Symphony #6, “Pastoral”
Track: Mozart: Clarinet Concerto In A, KV 622-1. Allegro
Artist: Alfred Prinz, Karl Böhm; Vienna Philharmonic Orchestra
Album: Mozart: Woodwind Concertos
Track: Dvorák: Slavonic Dance #2 In E Minor, Op. 46
Artist: Itzhak Perlman, Samuel Sanders
Album: Itzhak Perlman's Greatest Hits, Vol. 2

A method and system to provide a unified format for digital content metadata may, in some embodiments, prove beneficial to users such as application developers, online retailers and end users, because all four basic classical music data components—Composer/Recording, Artist/Album, Title/Track, and Title—may be accommodated on the three lines that are typically displayed by playback applications and devices. Data can be displayed consistently, such that the composer is distinguished from the performer—e.g., the composer data is not permitted to be displayed in the artist field. The use of the composer's name with the work title is thoroughly consistent with the listing of classical works in printed and scholarly matter and record products. A method and system to provide a unified format for digital content metadata may, in some embodiments, simplify the submit process for general public and may also alleviate the need for various makeshift methods that end users have been forced to use when submitting classical music data to a distributing or processing facility or entity.

The use of the composer and work at the Track level may contribute to solving various problems involved in the listing of opera tracks, particularly the assigning of individual vocalists to arias and duos/trios, etc. in individual scenes (tracks) in the order they appear on the track. The use of the composer's last name only (with qualifying initials when applicable) may provide the basic attribution to a specific work, but will not make the use of the composer's full name in a dedicated composer name field redundant. In some embodiments, the composer's name appears as part of the work title because the vast majority of classical titles are based on musical styles (e.g., symphonies, concertos, sonatas, partitas, etc.). Because there may be numerous Ninth Symphonies (by Haydn, Beethoven, Mozart, etc.), to refer to a “Ninth Symphony” in classical music does not convey sufficient information without a composer's name attributed to it. If extra data fields (and the means of displaying them) are available in the context of a playback device or application, the delimiters within track, album and artist names may be used to parse the information into the respective fields. Conversion of metadata associated with works of various genres into a display format associated with works of popular music may be described with reference to FIGS. 5-8.

FIG. 5 is a block diagram 500 illustrating conversion of metadata associated with a work of classical music into a display format associated with works of popular music, in accordance with one example embodiment. Pre-TLS data (classical data components 520) is based on Track #4 of the album “New World Symphony” featuring conductor George Szell and the Cleveland Orchestra. As shown in FIG. 5, a TLS interface/conversion module 510 receives the classical data components 520 and determines metadata 530. The TLS interface/conversion module 510 combines Album, Composer and Work fields to form an overloaded Album Title field (composer's full name is converted to Short Name). Composer, Work and Movement fields are combined to form an overloaded Track Title field. Artist type fields (here, Conductor and Ensemble fields) are combined to form an Album Artist field. Optional components, designated with an asterisk (“*”) are added to data strings with TLS-mandated delimiters. The metadata 530 is then re-configured into TLS data 540. The TLS data 540 is included into the three fields associated with popular music display format.

FIG. 6 is a block diagram 600 illustrating conversion of metadata associated with a work of classical music into a display format associated with works of popular music, in accordance with one example embodiment. Pre-TLS data (DVD data components 620) is based on the DVD, “Star Wars, Episode 4: A New Hope.” As shown in FIG. 6, a TLS interface/conversion module 610 receives the DVD data components 620, determines metadata 630, and generates TLS data 640. The TLS data 640, in this example, includes a DVD Title field, a Chapter field, and a Disc Artist field.

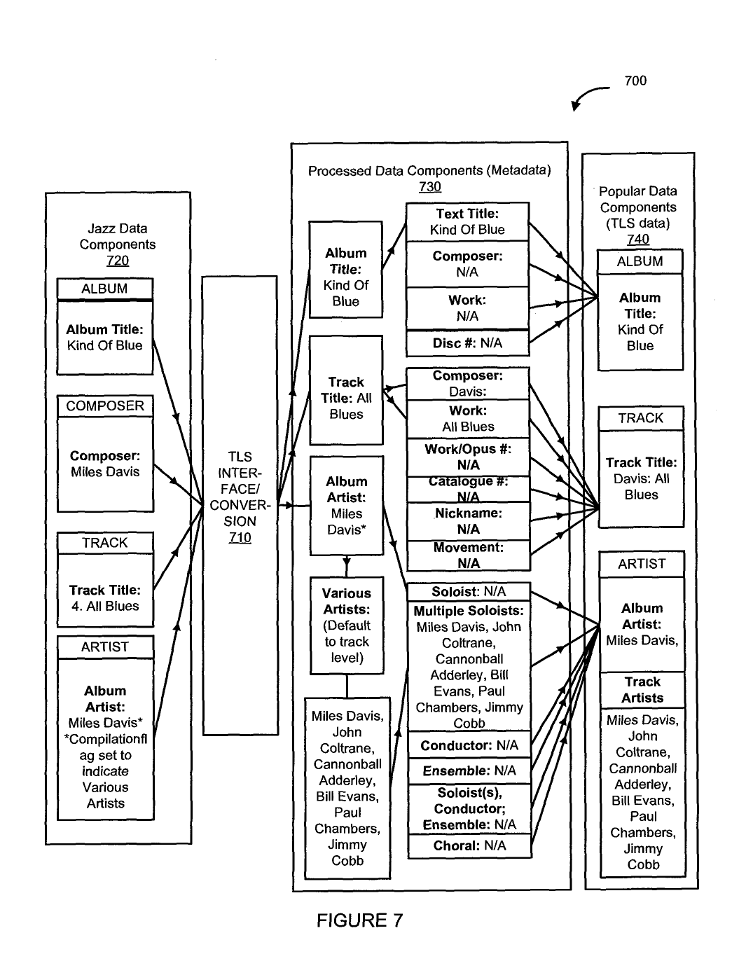

FIG. 7 is a block diagram 700 illustrating conversion of metadata associated with a work of classical music into a display format associated with works of popular music, in accordance with one example embodiment. Pre-TLS data (jazz data components 720) is based on Track #4 of the album “Kind Of Blue” by Miles Davis. As shown in FIG. 7, a TLS interface/conversion module 710 receives the jazz data components 720 and determines metadata 730. Album Title and Composer fields combined to form overloaded Album Title field (composer's full name is converted to Short Name). Composer and Track fields are combined to form overloaded Track Title field. Miles Davis is set as Album Artist and compilation flag is set to indicate separate track level artists. Compilation flag, in this example defaults to “Various Artists,” which, in turn, defaults to individual Track level artists. Track level artists data is reassembled in Multiple Soloists section. TLS data 740 is included into the three fields associated with popular music display format.

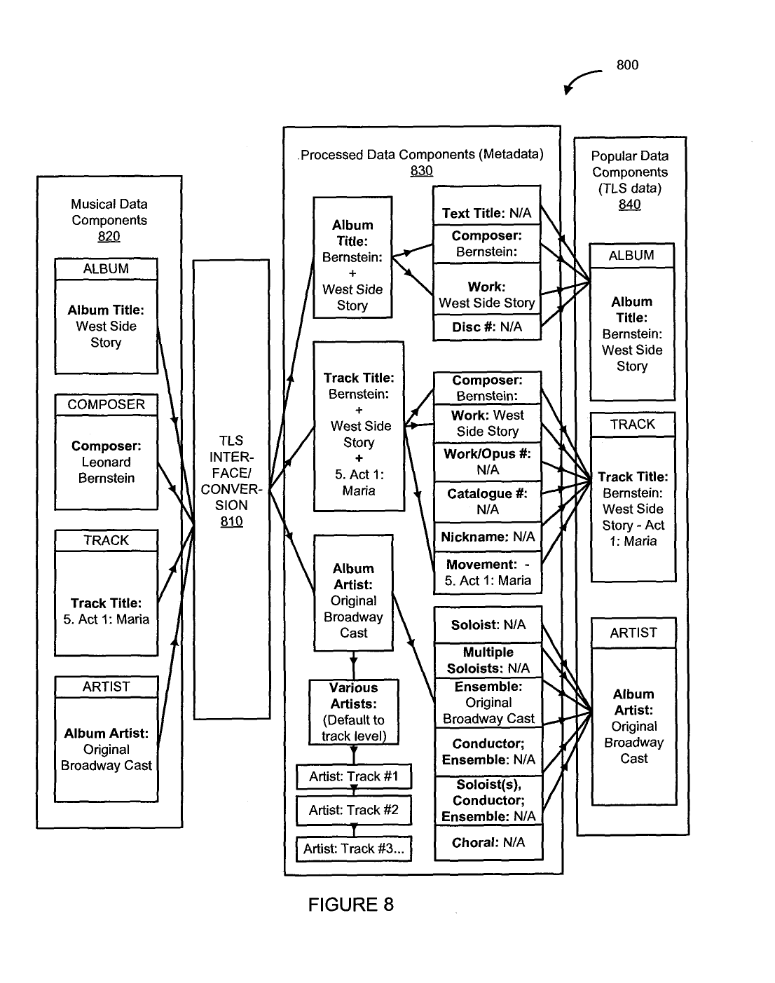

FIG. 8 is a block diagram 800 illustrating conversion of metadata associated with a work of classical music into a display format associated with works of popular music, in accordance with one example embodiment. Pre-TLS data (jazz data components 820) is based on Track #5 of the Original Cast recording of “West Side Story.” As shown in FIG. 8, a TLS interface/conversion module 810 receives data associated with the four lines of basic Broadway Musical data: Album Title, Composer(s), Work Title(s), Album Artist(s) (musical data components 820) and determines metadata 830. Album Title and Composer fields are combined to form overloaded Album Title field (composer's full name is converted into Short Name). Composer and Track fields are combined to form overloaded Track Title field. Artist(s) data is loaded into Album Artist field (with a default to Various Artists if there are different performers on each track). Mandatory and optional components are added to data strings with TLS-mandated delimiters. TLS data 840 is included into the three fields associated with popular music display format.

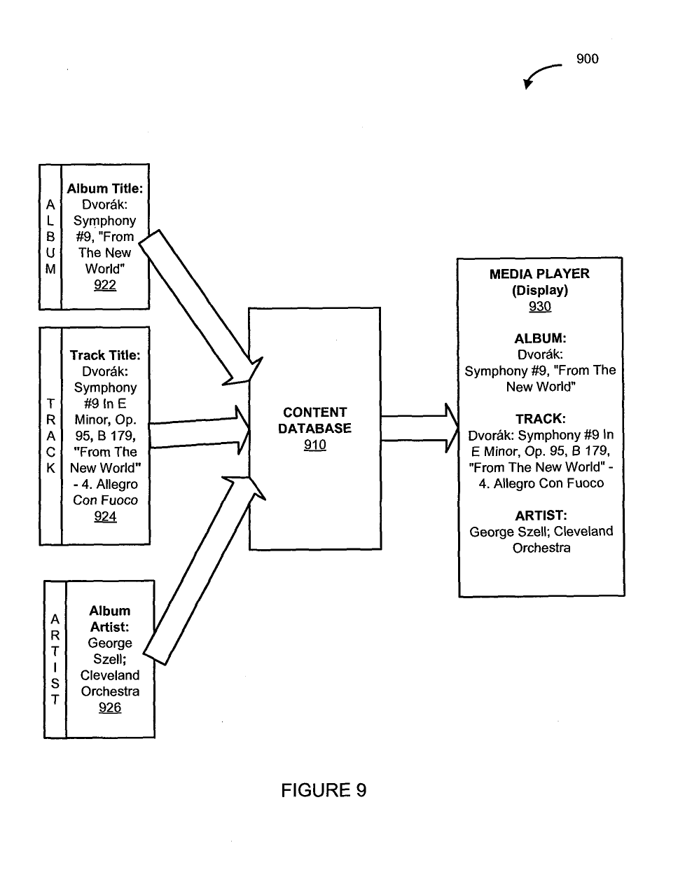

FIG. 9 is a diagrammatic representation of an architecture 900 for uploading TLS-formatted data to a content database for access by a media player. As shown in FIG. 9, classical data components based on Track #4 of the album “New World Symphony” are formatted into the tree field display format associated with popular music (blocks 922, 924, and 926). The TLS-formatted classical data components are uploaded to a content database 910. From the content database 910, TLS-formatted data may be provided to or accessed by a media player 930. It will be noted, that a media played may be in the form of a hardware device, in the form of a software application, etc.

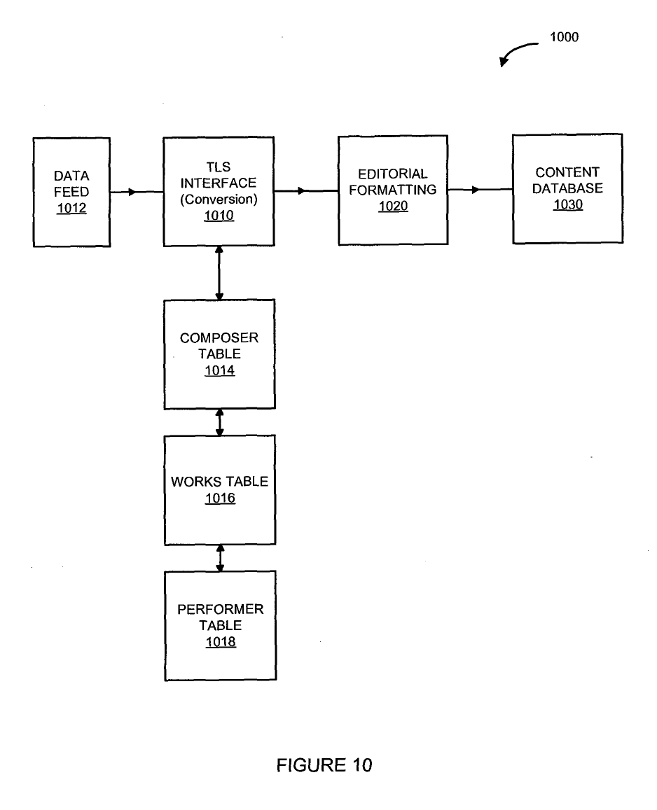

FIG. 10 is a diagrammatic representation of a server-side TLS conversion map 1000. As shown in FIG. 10, TLS interface 1010 receives a data feed 1012 (e.g., an audio content associated with a work of classical music). The TLS interface 1010 utilizes a composer table 1014, a works table 1016, and a performer table 1018 to process content received via the data feed 1012. The content processed by the TLS interface 1010 may be subjected to editorial formatting 1020. The formatted data is then uploaded to a content database 1030.

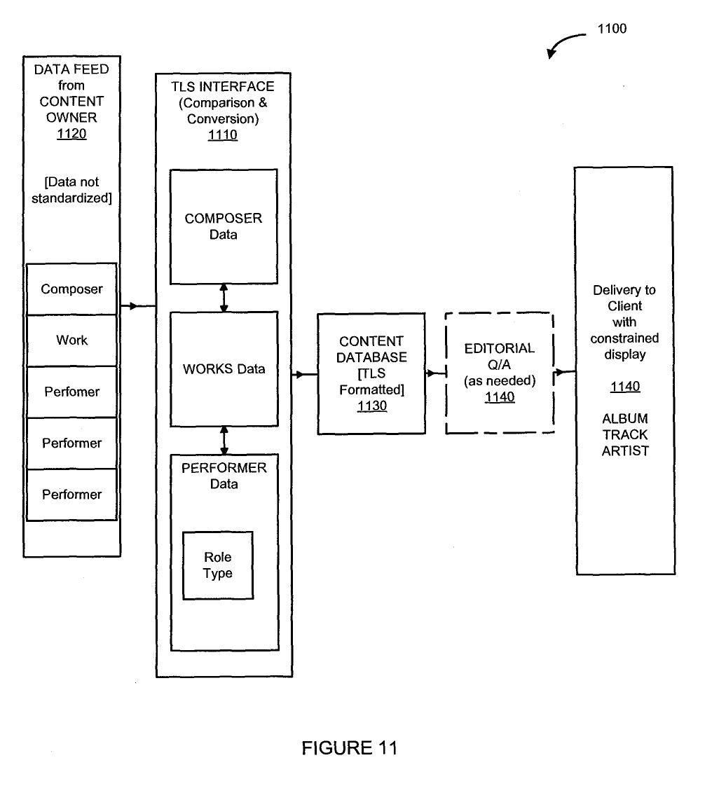

FIG. 11 is a diagrammatic representation of a more detailed server-side TLS conversion map 1100. As shown in FIG. 11, TLS interface 1110 receives a data feed 1020 (e.g., an audio content associated with a work of classical music). The TLS interface 1010 performs comparison and conversion operations to process content received via the data feed 11120. The TLS-formatted data is then uploaded to a content database 1030. The content processed by the TLS interface 1010 may be subjected to editorial quality assurance operations (Q/A) 1140. From the content database 1130, TLS-formatted (and, optionally, edited) data may be delivered to a client (block 1150).

### Example Classical Music Meta-Data Standards

Due to the complexity and variety of classical data and the way it can be listed, the TLS system may include a series of protocols and guidelines to be used at each level of the process. The protocols outline so-called macro rules, or “global” rules, and their exceptions that govern TLS data across the board, the ways the content metadata is organized and ultimately displayed. The guidelines may be viewed as micro rules, or “granular” rules that govern specific aspects of data strings.

### Example TLS Protocols:

Basic Usage Protocol (BUP) is described. The following are example general rules of data usage that may apply to the TLS system. These rules may include data strings that comprise the three basic fields that will be outlined on succeeding pages, as well as data strings contained in such specialized products as crossover, music/documentary, and opera recordings. Unless qualified, these rules pertains to the classical music data further below.

All words in a data string associated with a content item may be in “Init Cap,” format, i.e., the first letter of every word will be capitalized. This example convention applies to work titles as well as artist names.
Ex: Rachmaninov: Variations On A Theme By Paganini
Ex: Academy Of St. Martin In The Fields This will also apply to hyphenated words in non-English usage.
Ex: Bizet: L'Arlesienne Suite
Ex: L'Orchestre De La Suisse Romande

In the TLS data standards, punctuation often serves a delimiting purpose for the sorting of segments in a data string, e.g., by composer short name, work title, opus number, etc. These primary work/title segments may be separated from the movement data by a dash. After the dash in a track level data string, the use of punctuation, abbreviations, numbers and other qualifiers may generally follow the usage in the original submit or product, subject to BUP rules and prescribed data string lengths.

Delimiting punctuation may include colon, semi-colon, comma and dash in Album Title, Track Title and Artist Name strings. Example usage is illustrated in relevant sections listed below. Delimiting punctuation may also be used for non-delimiting purposes following a dash in an Album or Track Title string. Parentheses may be used in various ways, including separation of title from subtitle (e.g., Kreisler: Andantino (In The Style Of Martini)), separation of title from translation (e.g., The Firebird (L'Oiseau De Feu), separation of title from incidental data (e.g., The Firebird (1911 Version)), or separation of composer short name from qualifying initials (where applicable) (e.g., Bach (J S)).

The use of brackets may be reserved for use in the Album Title field to enclose the disc number in a set of discs, or a component of a multi-volume set of discs.
Ex: Wagner: Tristan Und Isolde [Disc 2]
Ex: Mozart: Complete Works, Vol. 9—Operas—Don Giovanni [CD 3]

Various commonly-used words, in classical data may be abbreviated or their common symbols may be used to conserve data string space. Some examples of abbreviations are shown below.
And=&
Volume=Vol.
Number/No.=#
Opus=Op.
Scene=Sc. (when used as the “scene” in an opera, ballet, etc.)*
*Not abbreviated when used as part of a formal title, e.g., Scene Du Ballet.

A composer's last name, or “short name” may be used in Album

Title and Track Title strings.
Ex: Johannes Brahms=Brahms
Ex: Wolfgang Amadeus Mozart=Mozart

In the case of composers who share a last name: initials and/or other qualifiers will be used as part of the short name, enclosed by parentheses.
Ex: Johann Sebastian Bach=Bach (J S)
Ex: Johann Strauss Sr.=Strauss Sr (J)
*Note: In one embodiment, abbreviations of “Jr.” and “Sr.” will not be followed by a period.

The use of prefixes in a composer's short name may be governed by the Common Usage Protocol (described below). Generally, prefixes such as “van,” “von” “de la,” “du,” etc. will not be used in a short name.
Ex: Franz Von Suppé=Suppé

If the prefix is commonly used in conjunction with a composer's last name, it may be made part of the short name.
Ex: Jean Baptiste Du Puy=Du Puy

At other times, particularly in the case of composers from the Medieval and Renaissance eras, a composer's first name may constitute the short name, based on common usage.
Ex: Josquin Des Prés=Josquin

The full names of artists will always be used, according to one example embodiment. Honorary titles such as “Sir,” “Dame,” and formal titles such as “King,” may be omitted.
Ex: Sir Georg Solti=Georg Solti
Ex: King Richard I=Richard I

Language-specific accents may be used in all titles and names. The use of accents in text, e.g., phrases and/or sentences in a string, is optional due to variables in text translations.
Ex: Bizet: L'Arlesienne Suite
Ex. Suppe=Suppé

The inclusion of translations of work titles may be made optional and subject to the Data String Length protocol. When included, the translation of the work title may be enclosed in parentheses—but not in quotation marks—and listed next to the title itself in the string.
Ex: Stravinsky: Le Sacre Du Printemps (The Rite Of Spring)

Arabic numbers will always be used, in one example embodiment, except in cases covered by the Common Usage Protocol, which is described further below. The use of articles in a title may be made optional. Product Integrity Protocol, described further below, may apply.
Ex: Stravinsky: The Firebird=>Stravinsky: Firebird

In album and track work titles, “Suite” may be included as part of the primary work title because it is commonly a distinct work (or a condensation of segments) from an original work of the same title.
Ex: Stravinsky: The Firebird Suite

For TLS purposes, terms such as “Book,” “Part,” and “Volume” (Vol.) may be considered to be subsets of a primary work and may be separated by a comma from the primary work title.
Ex: Bach (J S): Well-Tempered Klavier, Book 1

Use of Act and Scene in Work Titles: In (primarily) theatrical works such as operas and ballets, specific acts and scenes are part of a movement and therefore will be listed after the dash in a data string. Act number will be followed by a colon. Scene will be abbreviated (Sc.) and followed by a dash.

### Example Common Usage Protocol (CUP)

While the TLS system, in one example embodiment, codifies usage of various aspects of classical music data, exceptions may be encountered. In this case, the CUP will apply. For TLS purposes, “Common Usage” is defined as the non-TLS use of names, titles, punctuation, etc., when TLS guidelines conflict with prevailing academic or popular standards of usage and/or display. The use of CUP is an editorial call and may apply on a case-by-case basis.
Translations: In the case of a work title, English translations will usually apply except when the language-specific title is the one most commonly used.
Ex: Berlioz: Symphonic Fantastique. The French-language title is always used for this work, therefore it will not be translated as “Fantastic Symphony.”
Numbers: Use of Arabic numerals is standard in TLS. However, if a Roman numeral is integral to the application of a name, CUP will apply.

Ex: Richard I will not be listed as Richard I. (Note: In keeping with the exclusion of honorary titles in TLS, “King” will not be included in this composer short name).

### Example Product Integrity Protocol (PIP)

The Product Integrity Protocol (or PIP), in one example embodiment, is a product-related variation of the CUP. It may apply to officially-sanctioned data that is provided by record labels or that can be verified from the product itself PIP allows for the listing of data as it appears on a product, subject to the TLS format process, to accommodate the editorial preferences of the artist, label, producer, etc. This ranges from the choice of translations of a work, to the sequence of movements, punctuation not related to TLS-mandated delimiters, listing of singing roles on opera tracks, supplemental information about a work or track (e.g., version date or number), all of which may be included within the Data String Length Protocol.
Ex: (Product A): Mozart: Don Giovanni, KV 527—Act 1: Notte E Giorno Faticar
Ex: (Product B): Mozart: Don Giovanni—Act 1: Notte E Giorno Faticar (Leporello)
Ex: (Product A): Stravinsky: L'Oiseau De Feu—2. Kashchie's Magic Garden
Ex: (Product B): Stravinsky: Firebird (1911 Version)—Kashchie's Magic Garden

### Example Data String Length Protocol (DSL)

In order to conserve space in data strings, various segments of the data may be designated as “mandatory” or “optional.” The length of a string may be governed by the number of spaces needed to display all mandatory data and therefore can be as long as necessary. In one example embodiment, the DSL is not a limit, but a threshold designating the point at which optional data may or may not be added to a string. This threshold may be designated, for example at 70 spaces or less per string.

### Example TLS Guidelines—The Three Basic Fields:

As mentioned above, the three basic fields in the TLS system are

Album Title, Track Title, and Artist Name (for Album and Track level artists). In the examples below, each aspect of data is separated by specific punctuation (commas, semi-colons, colons, and dashes), according to predetermined order.

### Part 1—Album Title:

Titles of classical albums vary in form and complexity. Generally, if the data is coming directly from a product (e.g., a compact disc) or via an officially-sanctioned submit procedure, the PIP will apply. It will be noted, however, that even in these cases the concept of an “album title” may be ambiguous. When a product or officially-sanctioned data is not available, album titles may be formulated based on TLS standards and defaults as applied to the work(s) featured in the album. Titles for Crossover, Music Documentary and Opera albums are discussed further below

### Title Types

Formal titles, in which the title is text-based, as opposed to a listing of composers, performers and/or specific works, may be used verbatim.
Ex: The Best Of The Baroque
Ex: Pavarotti Sings Italian Arias

In text titles that are divided into distinct “sections,” a dash will separate one section from the next.
Ex: The Best Of The Baroque—Vivaldi
Ex: Pavarotti Sings Italian Arias—Puccini

Whenever a composer and a work are featured in a title, the composer's short name is followed by a colon.
Ex: The Best Of The Baroque—Vivaldi: The Four Seasons

When a product is a set of works without a text title, a title will be created with the composer's short name, a colon and the featured composition(s).
Ex: Strauss (R): Till Eulenspiegel's Lustige Streiche

In an album features two or more works by the same composer the works will be separated by a comma.
Ex: Strauss (R): Till Eulenspiegel's Lustige Streiche, Don Juan

In an album that features works by more than one composer, each composer/work data set will be separated by a semi-colon.
Ex: Schubert: Symphony #8; Vivaldi: The Four Seasons

In an album that contains works by more than two composers, the use of “Etc.” is optional after the second composer/work set (separated from previous work by a semi-colon) to conserve space in the data field.
Ex: Mozart: Symphony #25; Haydn: String Quartet #2; Etc.

### Abbreviations

BUP-related abbreviations listed above will apply. In one embodiment, work numbers in titles will use the “#” symbol (as opposed to “No.” or other words or symbols). The symbol “&” will be used instead of “and,” and “Vol.” instead of “Volume.”
Ex: Beethoven: Symphony #5
Ex: Bach (J S): Prelude & Fugue
Ex: Schubert: Lieder, Vol. 2

### Translations

Language-specific titles will be displayed exactly as they are presented on the product (when available), for works and artists.
Ex: Le Quattro Stagioni (as opposed to “The Four Seasons”)

When a product or officially-sanctioned data is not available, work/artist(s) will default to English unless CUP dictates otherwise (e.g., Berlioz's Symphonie Fantastique, etc.). When two or more language-specific versions of a title are commonly used, the title will default to English.
Ex: Stravinsky: The Firebird
*Note: Stravinsky's original French title, L'Oiseau Du Feu, will default to its English counterpart because both titles are used interchangeably.

### Subtitles

Subtitles are addendums to a work's title. These are included following the title, enclosed by parentheses. Inclusion into the Title field is optional.
Ex: Walton: Hamlet (A Shakespeare Scenario In 9 Movements For

Large Orchestra)

### Nicknames/Alias

Nicknames and aliases are additional—but separate—component of a title of a work. When included into the Title field, nicknames and aliases may be enclosed in quotation marks. As with subtitles, inclusion into the Title field is optional.
Ex: Beethoven: Symphony #9, “Choral”

### Instrument Attributions

Instrument attributions will be included into the Title field if they are part of the formal title of the work.
Ex: Bartók: Music For Strings, Percussion & Celeste

For works, in which the instrument attributions are parenthetical to the title, their use is optional (subject to DSL).
Ex: Schoenberg: Verklärte Nacht (For String Orchestra)=Schoenberg: Verklärte Nacht

For works that feature a solo instrument, the instrument will precede the work style.
Ex: Grieg: Concerto For Piano In A Minor, Op. 16=Grieg: Piano Concerto In A Minor, Op. 16

Supplemental instrument attributions are optional (subject to DSL) if they are solely used to denote a specific version of a work as played by an instrument(s), for which the work was not originally intended.
Ex: Benda (J A): Violin Concerto In G (Cello Version)=Benda (J A): Violin Concerto In G

### Numbered Works in Title

In Album Title, a series of numbered works will use the plural form and “#” (with the first number) to list the works.
Ex: Beethoven: Symphonies #2 & 3

### Multi-Disc Set Numbering

If a compact disc (CD) is part of a multi-disc set, the disc number will be included in the title, delineated by “Disc” enclosed by brackets.
Ex: Mozart: Don Giovanni [Disc 2]

In this example, “Disc” represents the second disc of a two-disc set of the opera.

If a CD is part of a volume of discs which is part of an all-encompassing multi-volume set, the volume number will be included in the album title and the number the of CD in that volume will be designated by “CD” in brackets.
Ex: Mozart: Complete Works, Vol. 9—Operas—Don Giovanni [CD 35]

In this example, the CD is number 35 of a 44-CD volume (Vol. 9) of a 170-disc set. The use of “CD” in brackets as opposed to “Disc” indicates its number in the volume. The “disc” number (for the entire set) is 165 of 170. Its use is optional.

### Part 2—Track Titles:

In the TLS system, in one example embodiment, track titles will generally follow the guidelines for album titles, but on a strictly work-level basis. However, track titles will usually involve more complex data strings, delimited punctuation and the added complexity of movement data. Track titles for crossover, music documentary and opera albums will be discussed further below.

In one example embodiment, track titles are divided into two sections, Work Title and Movement Title, separated by a dash. Mandatory (m) and optional (o) components of the specific work in the order as follows. Composer short name (m) followed by a colon; formal work title or musical style (m) followed by a comma; instrument attribution, if any,) followed by a comma; key signature (o) followed by a comma; opus number (o) followed by a comma; catalogue initial(s) and number (o) followed by a comma; and nickname/alias (o) if any.
Ex: Dvo\check{r}ák: Symphony #9 In E Minor, Op. 95, B 178, “From The New World”

A “movement”—as defined by TLS—is the smallest constituent part of a work. It is separated, according to one e section by a dash. Movement-level components include track or movement number, act and scene numbers, formal text titles, tempo designations, etc.
Ex: Dvo\check{r}ák: Symphony #9 In E Minor, Op. 95, B 178, “From The New World”—1. Allegro

Variations may be allowed in the listing of tempi, text titles, track numbers, movement numbers and other movement-level components. Following a dash that separates the work title from the movement title in the data string, punctuation does not serve a delimiting purpose and its use is variable according to that of a product. In the following examples, all three are permissible.
Ex: Grieg: Peer Gynt Suite #1, Op. 46—3. Anitra's Dance—Tempo Di Mazurka
Grieg: Peer Gynt Suite #1, Op. 46—Anitra's Dance, Tempo Di Mazurka
Grieg: Peer Gynt Suite #1, Op. 46—Anitra's Dance

Movement/Track Number vs. Work Number: After the dash in the data string, the numbering of the actual track will be based on two criteria. (1) If the data indicates a movement number of a work, a numeral will be used followed by a period.
Ex: Vivaldi: The Four Seasons, Op. 8/1, “Spring”—1. Allegro

(2) If the data indicates a distinct work within a set of works, “#” will be used followed by the numeral without a period.
Ex: Chopin: Etudes, Op. 10—#1 In C

Example of Sets of Works are shown further below. Track titles will reflect the language of the encompassing work.
Ex: For Le Quattro Stagioni, the Track Title is:
Vivaldi: Le Quattro Stagioni, Op. 8/1, “La Primavera”—1. Allegro
Ex: If the Album Title is The Four Seasons, the Track Title will be:
Vivaldi: The Four Seasons, Op. 8/1, “Spring”—1. Allegro

In one embodiment, track titles will always adhere to the actual tracks of an album. Different products will feature differing versions of the same work. This should be reflected in the track data string.
Ex: (Product A) Vivaldi: The Four Seasons, Op. 8/1, “Spring”—1. Allegro (this track includes the first movement of “Spring”)
Ex: (Product B) Vivaldi: The Four Seasons, Op. 8/1, “Spring” (this track includes all three movements of “Spring”)

Works that comprise part of a set of works can be listed two ways: (1) with the set as the work title and the individual component work as the movement, or (2) the individual component work as the work title.
Ex. (1): Chopin: Etudes, Op. 10—#1 In C
Ex. (2): Chopin: Etude #1 In C, Op. 10

When the set is designated by an opus number, a variation would include the component work's number (in the set) with the set's opus number separated by a slash.
Ex: Chopin: Etudes, Op. 10/1—In C

When the opus number applies to the component work instead of the set, the opus number will be listed with the component work in the data string's movement section.
Ex: Mozart: Church Sonatas—#14 In C, K 278

The two basic methods listed above extend to sets with “text” (as opposed to “generic,” e.g., style of music) titles.
Ex. (1): Dvo\check{r}ák: Slavonic Dances—#1 In G Minor
Ex. (2): Dvo\check{r}ák: Slavonic Dance #1 In G Minor

As with other works that are part of all-encompassing sets or “generic” musical types, choral works and vocal music are listed in various ways. Note that text title sections of works are enclosed in quotation marks when they constitute a nickname in the data.
Ex: Bach (J S): Cantata #211, BWV 211, “Schweigt Stille, Plaudert Nicht”=Bach (J S): Schweigt Stille, Plaudert Nicht=Bach (J S): Cantata #211

In the first example (above), “Schweigt Stille, Plaudert Nicht” is enclosed in quotes because it is used as a subtitle to the formal work title, Cantata #211. In the second example, it is not in quotes because it is used as the formal work title. In the third example, the Cantata and its number are the sole work title in the same manner as a symphony, concerto, etc. In all cases, the PIP will apply as long as method (1) or (2) is followed consistently within the product itself.

In many older works from the Medieval and Renaissance periods, the composer's name is not known. For this, use “Anon” (Anonymous) instead of the composer's name (without a period, followed by a colon) in place of the composer short name.
Ex: Anon: The Queen's Delight

Use of Trad: If an anonymous work is part of a generally-accepted folk tradition, “Trad” is used (without a period, followed by a colon) in place of the composer short name.
Ex: Trad: She Moved Through the Fair

When an original work has been transcribed or arranged by a second composer, the original composer's short name will be listed first in the data string followed and slash and then the secondary composer's short name.
Ex: Beethoven/Liszt: Symphony #9

(This is the listing for Liszt's piano transcription of Beethoven's Ninth Symphony.)
Ex: Mussorgsky/Ravel; Pictures At An Exhibition

This is the listing for Ravel's arrangement of Mussorgsky's Pictures At An Exhibition.

Translation of a work may be included as long as its inclusion does not create an unduly long data string as defined by DSL. Translations, when included in the track title, will be enclosed by parentheses.
Ex: Stravinsky: Le Sacre Du Printemps (Rite Of Spring)

Title Sequencing: The primary work title should always be used in the front end of a track listing and any attributive words—“from,” “of,” etc.—will be deleted.
Ex: Weber: Overture from Der Freischütz, J 277=Weber: Der Freischütz, J 277—Overture

(This rule is an override of the PIP.)

In the case above, the overture is a constituent part of a larger work, therefore it appears after the dash. In the case of overtures and other incidental works that are distinct individual pieces of music, a formal title will apply.
Ex: Beethoven, Egmont Overture, Op. 84

Subtitles may be included following the primary work title, enclosed in parentheses. Subtitles are defined as addendums to a work's title. Inclusion of subtitles is optional.
Ex: Walton: Hamlet (A Shakespeare Scenario In 9 Movements For Large Orchestra)

A nickname, or alias is defined as a supplementary title to a work's primary title and is enclosed by quotation marks. Its inclusion is optional.
Ex: Beethoven: Symphony #9, “Choral”

Attributive Subtitles: These are subtitles that make reference to another composer or work. If the attribution is part of the formal title, it will not be enclosed by parentheses:
Ex: Rachmaninov: Variations On A Theme By Paganini

If the attribution is a part of the title but is used as an addendum, it will be enclosed by parentheses.
Ex: Koshkin: Usher Waltz (After Edgar Allan Poe), Op. 29

Extraneous/Optional data may be deleted if other parts of the string provide the same information.
Ex: Schubert: Pensa Che Questo Istante, D 76A (First setting)
Schubert: Pensa Che Questo Istante, D 76B (Second setting)

In this case, the parentheticals may be deleted because the same info is provided by the “A” and B″ in the opus number.

In album and track work titles, “Suite” may be included as part of the primary work title because it is commonly a distinct work (or a condensation of segments) from an original work of the same title.
Ex: Stravinsky: Firebird Suite

The use of “Book,” “Part” and “Volume” (abbreviated to “Vol.”)

are, for TLS purposes, considered “chapters”—as opposed to individual movements—of a primary work and may be separated by a comma from the primary work title.
Ex: Bach (J S): Well-Tempered Klavier, Book 1

In (primarily) theatrical works such as operas and ballets, specific acts and scenes are part of a movement and may be listed after the dash in a data string. Scene will be abbreviated by, “Sc.”
Ex: Mozart: Cosi Fan Tutte, KV 588—Act 1: Sc. 1—Una Bella Serenata

### Opus Guidelines

Additional opus abbreviations—Op. Posth—should not be followed by a period.
Ex: Medtner: Piano Quintet In C, Op. Posth—Molto Placido

Secondary/tertiary opus numbers will not be included.
Ex: Grieg: Peer Gynt, Op 55/5 (Op. 23/9)—Dance Of The Mountain King's Daughter=Grieg: Peer Gynt, Op 55/5—Dance Of The Mountain King's Daughter

Works “Without Opus” may be abbreviated as WoO (Init Cap will not apply) without a period and applies to the works of all composers that have not been assigned opus numbers for publication.

Movement opus numbers are numbers that are assigned to movements or sections within primary works or sets of works. In this case, the opus numbers may be listed as part of the movement title following the dash in the data string.
Ex: Grieg: Piano Transcriptions Of Songs #2, Op. 52—Solveig's Song, Op. 23/18

### Catalogue Guidelines

Cataloguers' Initials may follow the commonly-used initialing system. In the case of the works by Vivaldi, for example, the catalogue initials “R” and “RV” refer to two separate cataloguers and the latter therefore will not be shortened to “R.” The opposite is the case with the Köchel/Mozart catalogue, in which “K” and “KV” (or “Kv”) are interchangeable. Also, Init Cap does not apply to cataloguers' initials—in some cases (e.g., above) both letters are generally capitalized, but in others (“Wq” for the works of Gluck and C. P. E. Bach) the second letter is generally in lower case. The PIP applies to catalogue initials.

Multiple catalogue numbers will not be included. Instead, the catalogue number will default to the first catalogue number that is generally listed.
Ex: Scarlatti (D): Keyboard Sonata In D, K 96/L 465/P 210—Allegrissimo=Scarlatti (D): Keyboard Sonata In D, K 96—Allegrissimo

Addendums to catalogue data may be included when available. The addendum is Init Cap and is not followed by a period.
Ex: Haydn: Piano Sonata #18 In E Flat, Hob Deest 16—Menuetto

(“Deest” is an abbreviation for a work that has been subsequently added to the original “Hob” catalogue).

“Ahnhang” (addendum or appendix) will be abbreviated as “Ahn” without a period.

### Detailed Example of a Track Title

Applying TLS standards to a track title, a complete listing (including mandatory and optional data) of the first movement Antonin Dvo\check{r}ák's Ninth Symphony would result in the following.
Dvo\check{r}ák: Symphony #9 In E Minor, Op. 95, B 178, “From The New World”—1.

### Adagio

The example Track Title above is made up of the following components.
Composer's Short Name (followed by a colon): Dvo\check{r}ák:
A composer's Short Name comprises their Last Name, with first initials or other qualifiers in parentheses if the last name is shared with another composer, i.e. Bach (J S) or Strauss Jr. (J).
Work Title: The name of the work, which often equates to the musical style (followed by a comma except, as in this case, when a key signature is included as part of the work title): Symphony #9.
   Note: Text/title works, i.e. Stravinsky: The Firebird follow the same sequence. The title will not be enclosed by quotation marks.
Key Signature: When included, minor and flat/sharp designations are spelled out and capitalized (followed by a comma). “In E Minor,”
   Note: The use of “Major”after a key signature is redundant and will not be used. The key signature addendums, Sharp and Flat, will be used instead of their symbols.
   Note: Non English usage of “major” and “minor” (i.e. “dur,” “moll”) will be used only if specified by the product or officially-sanctioned submit and must be consistent with the language usage in the title itself).
Opus Number: The number of a published work. Use abbreviation and Arabic numeral (followed by a comma). “Op. 95,”
   Note: In the case of sets of works organized in the same Opus, the opus number includes the opus number itself and the distinct work/movement, etc. that is part of it separated by a forward slash. Op. 8/1.
Catalogue Number: The official catalogue number of a work (if a composer's body of work has been compiled by a generally-acknowledged scholar) follows the Opus number (and is followed by a comma if there is also a “nickname” title). “B 178,”
   Note: There is no period after catalogue initial(s).
Nicknames/aliases: Title nicknames are listed after the catalogue number and enclosed in quotation marks: “From The New World.”
Dash: A dash separates the formal work title (and accompanying data) from the movement data (if any).
Movement Number: Use of track/movement numbers is optional in works which feature generic tempo, dance or other words/terms that recur in movement titles, i.e. Allegro, Adagio, etc. This will include many concertos, symphonies etc. primarily from the Baroque and Classical eras. This also applies to sacred works in which specific movement text titles, are used recurrently. Movement numbers must be displayed in Arabic numerals (followed by a period).
   Ex: Dvo\check{r}ák: Symphony #9 In E Minor, Op. 95, B 178, “From The New World”—1.
   Note: Numbers will not be used for works with movements that have distinct text titles, i.e. Mussorgsky: Pictures At An Exhibition—The Marketplace At Limoges, or Berlioz: Symphonie Fantastique, Op. 14—Songe D'Une Nuit Du Sabbat). However, track numbers are permitted in cases where PIP applies.
Movement Title: Usually a tempo marking:
   Ex: Dvo\check{r}ák: Symphony #9 In E Minor, Op. 95, B 178, “From The New World”—1. Adagio

### Part 3—Artist Name(s)

The Artist in all artist fields is defined as the Performing Artist, not the composer. The performer(s)' full name is always listed. Because “artist” can assume many forms in classical music, the TLS standard divides them into six basic categories.
1. Soloist: An individual instrumentalist/vocalist performing alone.
   Ex: Yo-Yo Ma
      The listing of an accompanist(s) is optional, when the product is attributed primarily to the solo performer. They are separated by a comma.
         Ex: Anne-Sophie Mutter or, Anne Sophie Mutter, Lambert Orkis
2. Multiple Soloists: When a product features two or more artists playing as an (unnamed) ensemble or in various configurations these are listed in order on the product (from left-to-right, or, top-to-bottom on the product cover). They are separated by commas with the last soloists separated by a comma, not “&.”
   Ex: Mstislav Rostropovich, Martha Argerich
   More than two soloists, the use of “Etc.” is optional.
   Ex: Mstislav Rostropovich, Martha Argerich, Etc.
      Conductor and ensemble count as one performer when listed with soloists and follow the soloists in the string.
         Ex: Mstislav Rostropovich, Martha Argerich, Simon Rattle; Berlin Philharmonic Orchestra
3. Ensemble: This is defined as a group of musicians performing under a formal name.
   Ex: Berlin Philharmonic Orchestra
      Tokyo String Quartet
      For individuals who comprise an artistic “team,” use “&.”
      Ex: Katia & Marielle Labeque
4. Conductor; ensemble: Conductor (separated by a semi-colon) should be listed before ensemble.
   Ex: Leonard Bernstein; New York Philharmonic Orchestra
5. Soloist w/conductor; ensemble: Soloist (separated by comma) should be listed before conductor and ensemble.
   Ex: Simon Standage, Trevor Pinnock; English Concert\Featured vocalist(s) and narrator(s) may be treated the same as an instrumental soloist.
   Ex: Dawn Upshaw, Michael Tilson Thomas; San Francisco Symphony
6. Conductor; ensemble w/featured vocalists and vocal ensembles in a choral setting: The vocalist(s) will be listed before the conductor and choral group(s) after the ensemble.
   Ex: Julia Hamari, Karl Bohm; Berlin Philharmonic Orchestra & Choir

Album-level artist names associated with Compilation releases should adhere to the following guidelines. If there are multiple combinations of soloists, conductors/ensembles and or other artists, the Album Artist will be designated “Various Artists” and the individual artist name(s) will be listed at the Track level. If there are multiple conductors performing with the same ensemble, the ensemble's name will be the Album Artist, and the individual conductors' names (with the ensemble) will be listed at the Track level. If there are multiple ensembles performing with the same conductor, the conductor's name will be the Album Artist and the conductor's name (with the individual ensembles) will be listed at the Track level.

### Part 4—Other Data (If Applicable)

Data other than that in the Album Title/Artist/Track fields (which have been described above) may adhere to their own specific standards as related to classical music.
Data Language: This is the language in which an album's liner notes are written. Because many classical albums have multi-language notes, English will be used any time that it is included in the product. For language-specific non-US albums, list the language that is used.
Disc #'s: If the product is a single-CD release, it will be designated “1” of “1.” If part of a set, it will be “1” of “5”, “2” of “5,” etc.
Compilation: An album is a compilation if it features various artists at the track level and/or an album credited to a featured soloist performing with various artists at the track level.
Label Field: When indicated on the album cover, the label will be the specific recording label that is issuing the product, as opposed to its larger distributor.
   Ex: Deutsche Grammophon would be the listed label, as opposed to Universal.
Primary Genre/Secondary Genre: The general guideline is:
   The Primary Genre of a composer should be their musical era, i.e. Medieval, Renaissance, Baroque, Classical, Romantic, Impressionist, Modern (approx. 1900-1950) and Contemporary (1950-Present). Secondary Genre is left blank.
   The Primary Genre of a performing artist should be their primary instrument. Secondary Genre can be by era/style if applicable, i.e. “Early Music.”
      Ex: J. S. Bach's primary genre would be Baroque Era.
      Ex: The primary genre for pianist Glenn Gould would be “Piano” and the Secondary Genre would be related to the specific era which he is performing on the product. If more than one era is being performed, do not list a Secondary Genre

### Part 5—Opera

While opera is usually considered a part of classical music, it is in fact a separate genre with its own set of data demands. Many of these are met by the TLS standards above and should follow those standards when they apply. Below are some example exceptions.

Album Title may be included with the composer's Short Name (followed by a colon) and the text title of the opera without additional Opus or catalogue numbers.
Ex: Puccini: Tosca

Disc number may be included in brackets if the CD is part of multi-disc set.
Ex: Wagner: Tristan Und Isolde [Disc 2]

Album Artist field may include the two lead vocalists along with the conductor and ensemble. The use of “Etc.” indicates additional cast.
Ex: Maria Callas, Renato Cioni, Etc., Carlo Felice Cillario; Orchestra Of The Royal Opera House

Track Title (before the dash) may include composer's Short Name and the opera title with opus and catalogue data being optional.
Ex: Mozart: Cosi Fan Tutte, KV 588

Operas will be credited to the composer and will not include the name of the librettist with the exception of a composer/lyricist team.
Ex: Gilbert & Sullivan: Pirates Of Penzance

Following the dash, act and scene data can vary according to the product or submit, ranging from act and scene numbers, to designations of arias, recitatives, etc., text excerpts from the scene, the names of roles being sung and stipulations for instrumental ensembles/sections between acts.
Ex: Mozart: Cosi Fan Tutte, KV 588—Act 1: Sc. 1—Una Bella Serenata
Mozart: Cosi Fan Tutte, KV 588—Act 1: Terzetto—Una Bella Serenata
Mozart: Cosi Fan Tutte, KV 588—Una Bella Serenata

While the Album Artist will generally suffice for opera CD data, TLS allows submitters the capability to include the featured soloists on each track, in the order they appear on the track, along with the conductor and ensemble. For example, in a version of “Tosca” featuring Maria Callas in the title role and Renato Cioni as Cavaradossi, the libretto lists Tosca and Cavaradossi as the featured characters in this duet, Track level artists for this track may appear as follows.
Ex: Maria Callas, Renato Cioni, Carlo Felice Cillario; Orchestra Of The Royal Opera House

For instrumental and/or choral passages without soloists, the conductor and ensemble will be the Track Artist (unless otherwise indicated).
Ex: Carlo Felice Cillario; Orchestra of the Royal Opera House

### Part 6—Music Education/Documentary Albums

In the context of classical music metadata, these are music-related CDs with musical performances and separate tracks featuring a narrator(s) and/or an actor(s). These are not to be confused with audio books, which have a separate set of standards. Generally, TLS standards will apply. However, exceptions in the three basic fields are shown below.

The formal title of the CD with first subsection (if any) separated by a dash.
Ex: Life & Works—Liszt

If the title includes a composer and a work(s), the composer's short name will be followed by a colon.
Ex: Opera Explained—Mozart: Così Fan Tutte

This also applies to non composers.
Ex: Art & Music—DaVinci: Music Of His Time

A performer's name will be followed by a dash.
Ex: Nigel Kennedy—The Art Of The Violin

An Album Artist may be the author of the text/dialogue.
Ex: Jeremey Siepmann

If a conductor, performer and/or ensemble is also featured as part of the product, the author's name will be listed first as a soloist(s), followed by a comma.
Ex: Jeremy Siepmann, Herbert Von Karajan; Berlin Philharmonic Orchestra

If the author and an actor(s) are credited, the author's name will be listed first and then the actor(s) separated (as with multiple soloists/ensembles) by a comma.
Ex: Jeremy Siepmann, Malcolm Sinclair

The track title will begin with the author's name followed by a colon and the track title.
Ex: Siepmann: Introduction To Cosi Fan Tutte

If a musical selection is included (without accompanying narration), the track will be listed as the TLS track for the given work.
Ex: Mozart: Cosi Fan Tutti, K 588—3. Act 1: Sc. 1—Fuor La Spada

The Track Artist may be the author and/or narrator.
Ex: Jeremy Siepmann

If the track includes narration and dialogue that is interspersed in the text, the author/narrator will be listed first, followed by the actor(s).
Ex: Jeremy Siepmann, Malcolm Sinclair

If a musical track is included, the artist will be the musical performer(s).
Ex: Herbert Von Karajan; Berlin Philharmonic Orchestra

### Part 7—Crossover Albums

“Crossover” albums, for the purposes of TLS standards, are defined as any product featuring a generally-acknowledged “classical” artist(s) performing non-classical music, and/or a non-classical artist(s) performing classical music and, in some cases, a combination of the two, e.g., Sting singing a duet with Luciano Pavarotti. In one example embodiment, these standards do not apply to film scores and stage musicals.

Formal Text Title of a crossover album will be listed verbatim.
Ex: Charlotte Church—Enchantment
Ex: Pavarotti & Friends

When an album features a “classical” work by a “pop” composer/artist, the listing will be the same as a TLS-formatted classical album.
Ex: Costello: Il Sogno

When a “classical” composer works in a “pop” context (with or without pop artists), the listing will also be in TLS format.
Ex: Glass: Songs From Liquid Days

A non-classical composer/artist adapting a classical format to a pop setting (e.g., The Who's rock opera, “Tommy”) will be listed in the pop format.
Ex (Album Title): Tommy
Ex (Album Artist): The Who

Liberal—if formalized—use of delimiters in a data string that comprises media content metadata may be advantageous in the context of facilitating interaction of the data string with other products that employ the pop music format. For example, the liberal yet formalized use of delimiters pertains to expanding the granularity of the data string to separate individual data components into normalized fields for incorporation into the display of a media player. In the case of classical music, for example, the use of delimiters may allow for “performers” data to be delineated by soloists, conductors, ensembles, choral groups, etc. In one example embodiment, a TLS system may be configured such that colon always precedes Ensemble(s) data, semicolon always precedes Conductor data, and comma(s) separates soloists and ensembles.

In the case of a movie (e.g., content stored on a DVD), the use of delimiters may allow for a display that could include various data components, from the movie title, to the cast (individually), director, screenwriter, year of release, etc.

It will be noted, that while the method and system to provide a unified format for digital content is described, largely, with reference to audio content, the techniques described herein may be utilized advantageously for other types of digital content, e.g., for digital video content, e.g., in the form of DVD, Blu-Ray and high definition (HD) DVD, etc. One example is illustrated in FIG. 6.

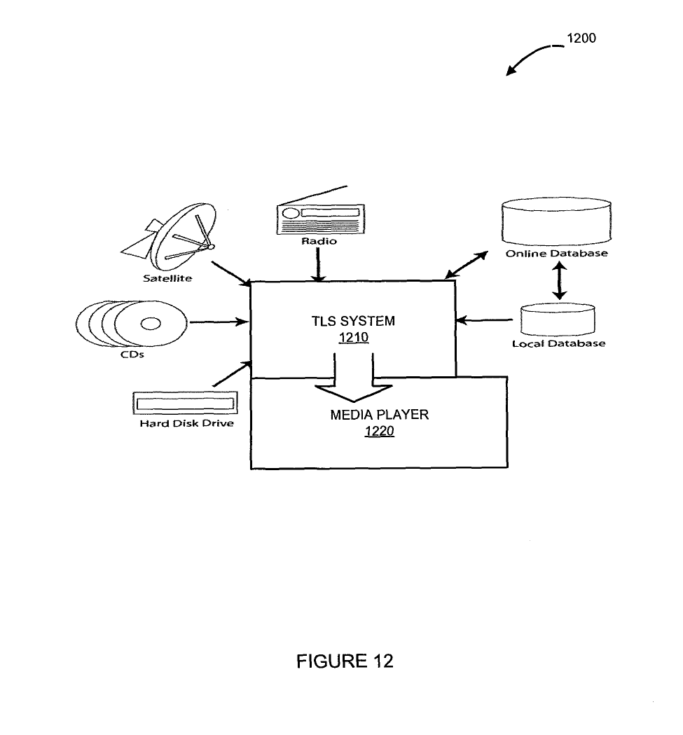

Various sources of media that may be available to a user associated with the client 110 of FIG. 1 are illustrated n FIG. 12 and also listed in Table 1 below.

TABLE 1
Example media sources

| Content on Fixed Media | Streamed Content |
|---|---|
| Audio CD | Digital Satellite and |
| | Terrestrial Radio |
| CD/DVD+/−R/RW | AM/FM Radio |
| HDD | Internet Radio |
| Flash/Solid State Memory | On-Demand |
| | Streaming |
| Tethered Storage, Portable | |
| Device, Mobile Phone | |

As shown in FIG. 12, in the context of an environment 1200, source content may be received at a TLS system 1210 from a hard disk drive, from CDs, via satellite communications, via radio communications, as well as from local and on-line databases. The TLS system 1210 may perform formatting operations in order to provide content metadata in a unified format to a media player 1220.

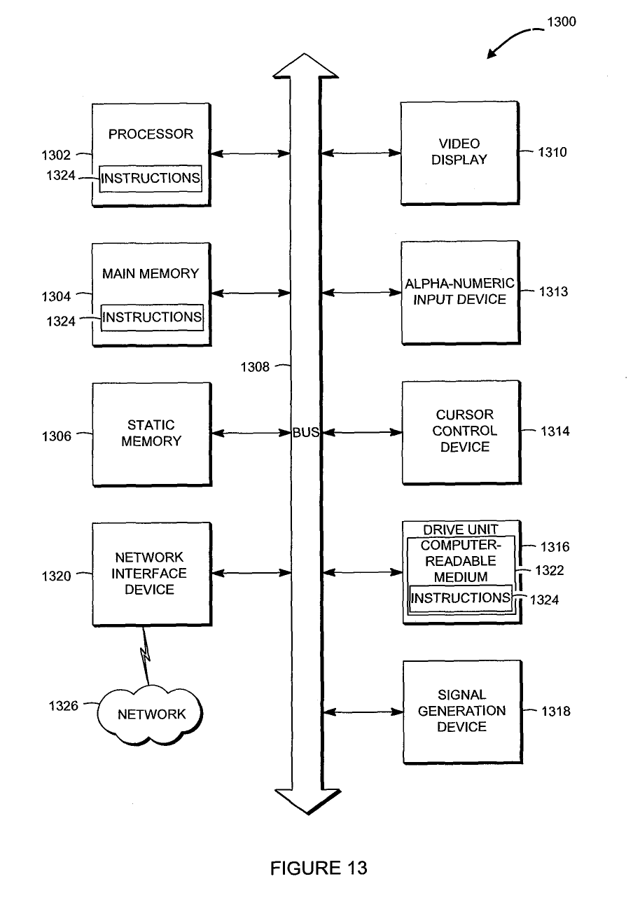

FIG. 13 shows a diagrammatic representation of a machine in the example form of a computer system 1300 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alpha-numeric input device 1312 (e.g., a keyboard), a user interface (UI) navigation device 1314 (e.g., a cursor control device), a disk drive unit 1316, a signal generation device 1318 (e.g., a speaker) and a network interface device 1320.

The disk drive unit 1316 includes a machine-readable medium 1322 on which is stored one or more sets of instructions and data structures (e.g., software 1324) embodying or utilized by any one or more of the methodologies or functions described herein. The software 1324 may also reside, completely or at least partially, within the main memory 1304 and/or within the processor 1302 during execution thereof by the computer system 1300, the main memory 1304 and the processor 1302 also constituting machine-readable media.

The software 1324 may further be transmitted or received over a network 1326 via the network interface device 1320 utilizing any one of a number of well-known transfer protocols (e.g., Hyper Text Transfer Protocol (HTTP)).

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system to provide a unified format for digital content metadata that may be implemented in an example form of TLS have been described. Embodiments of this solution may be utilized to accommodate the shift from the album as a distinct product, to individual tracks as the basic point-of-purchase. Using TLS, classical track data may be used as a unique, marketable data component, as opposed to tracks being parts of an all-inclusive Album. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
a communication module to obtain source data associated with media content;
a content identification module to identify the media content, utilizing the source data;
an extractor to obtain source metadata associated with the identified media content; and
a converter to format the obtained source metadata utilizing a format associated with popular music.

2. The system of claim 1, comprising a packaging module to generate packaged metadata based on the formatted source metadata.

3. The system of claim 2, comprising a renderer to render the packaged metadata.

4. The system of claim 1, wherein the format associated with popular music comprises at least one of an album field, a track field, or an artist field.

5. The system of claim 1, wherein the media content is audio content.

6. The system of claim 1, wherein:
the media content is associated with classical music; and
the source metadata comprises at least one of album data, composer data, music work data, movement data, conductor data, or ensemble data.

7. The system of claim 6, wherein the converter is to:
overload an album field with the composer data and the work data;
overload a track field with the composer data, the work data, and the movement data; and
overload an artist field with the conductor data and the ensemble data.

8. The system of claim 1, wherein the media content is associated with an opera.

9. The system of claim 1, wherein the media content is associated with jazz music.

10. A method comprising:
obtaining source data associated with media content;
identifying the media content, utilizing the source data;
obtaining source metadata associated with the identified media content; and
formatting the obtained source metadata utilizing a format associated with popular music.

11. The method of claim 10, comprising generating packaged metadata based on the formatted source metadata.

12. The method of claim 11, comprising rendering the packaged metadata.

13. The method of claim 10, wherein the format associated with popular music comprises at least one of an album field, a track field, or an artist field.

14. The method of claim 10, wherein the media content is audio content.

15. The method of claim 10, wherein:
the media content is associated with classical music; and
the source metadata comprises at least one of album data, composer data, music work data, movement data, conductor data, or ensemble data.

16. The method of claim 15, wherein the formatting of the obtained source metadata comprises:
overloading an album field with the composer data and the work data;
overloading a track field with the composer data, the work data, and the movement data; and
overloading an artist field with the conductor data and the ensemble data.

17. The method of claim 10, wherein the media content is associated with a musical.

18. The method of claim 10, wherein:
the source data is associated with a digital video disc (DVD); and
the source metadata comprises at least one of a disc title, a chapter title, director data, or cast data.

19. The method of claim 18, wherein the formatting of the obtained source metadata comprises:
overloading an album field with the disc title;
overloading a track field with the disc title and the chapter title; and
overloading an artist field with the director data and the cast data.

20. A machine-readable medium having instruction data to cause a machine to:
obtain source data associated with media content;
identify the media content, utilizing the source data;
obtain source metadata associated with the identified media content; and
format the obtained source metadata utilizing a format associated with popular music.
